(19) United States
(12) Patent Application Publication
(10) Pub. No.: US 2024/0310745 A1
(43) Pub. Date: Sep. 19, 2024

(54) COATING DEVICE AND METHOD FOR MANUFACTURING PHOTORECEPTOR

(71) Applicant: FUJIFILM Business Innovation Corp., Tokyo (JP)

(72) Inventors: Takaakira SASAKI, Kanagawa (JP); Masaru AGATSUMA, Kanagawa (JP); Takayuki YAMASHITA, Kanagawa (JP)

(73) Assignee: FUJIFILM Business Innovation Corp., Tokyo (JP)

(21) Appl. No.: 18/454,415

(22) Filed: Aug. 23, 2023

(30) Foreign Application Priority Data
Mar. 17, 2023 (JP) 2023-042817

(51) Int. Cl. G03G 5/05

(52) U.S. Cl. CPC G03G 5/0525

(57) ABSTRACT

A coating device includes: a coating liquid holding part having an upper opening portion and a lower opening portion and holding a coating liquid, in which a base material having a tubular shape penetrates the upper opening portion and the lower opening portion of the coating liquid holding part, and the coating liquid is applied to an outer peripheral surface of the base material by relatively moving the base material upward in an up-down direction; a container surrounding the coating liquid holding part and having, at an upper portion, an opening into which the base material penetrating the coating liquid holding part is inserted; and a vapor concentration holding part that holds solvent vapor concentration of a solvent contained in the coating liquid in a region determined from a liquid level of the coating liquid holding part at a value equal to or higher than a determined value until a determined range of an upper portion in an axial direction of the base material passes through the region.

### CROSS-REFERENCE TO RELATED APPLICATIONS

This application is based on and claims priority under 35 USC 119 from Japanese Patent Application No. 2023-042817 filed Mar. 17, 2023.

### BACKGROUND

### (i) Technical Field

The present invention relates to a coating device and a method for manufacturing a photoreceptor.

### (ii) Related Art

JP2000-305293A discloses a dip coating device for an electrophotographic photoreceptor that includes a dip coating tank which holds a coating liquid for forming a coating film of an electrophotographic photoreceptor and in which a cylindrical substrate is immersed, and a liquid feeding device for supplying the coating liquid to the dip coating tank, and that pulls up the cylindrical substrate immersed in the dip coating tank to form the coating film of the electrophotographic photoreceptor on the peripheral surface thereof, and in the dip coating device, a solvent vapor supply device is provided in an upper space of the dip coating tank.

JP2003-149836A discloses a method for manufacturing an electrophotographic photoreceptor by laminating n photoreceptor material layers on the surface of a cylindrical substrate, the method including: forming an n-2nd layer and an n-1st layer by dip coating using a dip coating device, in which a dip coating tank having a solvent vapor leak enclosure on at least an upper portion of an outer peripheral wall, and a stretchable hood enclosing the side of the cylindrical substrate are disposed, under conditions in which the viscosity of an n-1st layer coating liquid is higher than the viscosities of either an n-2nd layer coating liquid or an n-th layer coating liquid; and forming an n-th layer by spray coating.

### SUMMARY

Aspects of non-limiting embodiments of the present disclosure relate to a coating device and a method for manufacturing a photoreceptor, in which local film thickness unevenness of a coating layer of a base material can be suppressed compared to a case where solvent vapor concentration of a coating liquid in a region determined from a liquid level in a coating liquid holding part is lower than a determined value until a determined range of an upper portion in an axial direction of a base material passes through the region.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a coating device including: a coating liquid holding part that has an upper opening portion and a lower opening portion and holds a coating liquid, in which the coating liquid is applied to an outer peripheral surface of a base material having a tubular shape by causing the base material to penetrate the upper opening portion and the lower opening portion of the coating liquid holding part and relatively moving the base material upward in an up-down direction; a container that surrounds the coating liquid holding part and has, at an upper portion, an opening into which the base material penetrating the coating liquid holding part is inserted; and a vapor concentration holding part that holds solvent vapor concentration of a solvent contained in the coating liquid in a region determined from a liquid level in the coating liquid holding part at a value equal to or higher than a determined value until a determined range of an upper portion in an axial direction of the base material passes through the region.

### BRIEF DESCRIPTION OF THE DRAWINGS

Exemplary embodiment(s) of the present invention will be described in detail based on the following figures, wherein:

FIG. 1 is a cross-sectional view showing an outline of an overall configuration of a coating device according to a first exemplary embodiment;

FIG. 2 is a cross-sectional view showing a part of a coating liquid holding part that is used in the coating device according to the first exemplary embodiment in an enlarged state;

FIG. 3 is a perspective view showing a cylindrical body to which a coating liquid is applied and a holding member;

FIG. 4 is a cross-sectional view showing a first step of applying a coating liquid to the cylindrical body by using the coating device according to the first exemplary embodiment, and showing a state before the cylindrical body is inserted into the coating liquid holding part;

FIG. 5 is a cross-sectional view showing a second step of applying the coating liquid to the cylindrical body by using the coating device according to the first exemplary embodiment, and showing a state where the cylindrical body is being inserted and lowered into the coating liquid holding part;

FIG. 6 is a cross-sectional view showing a third step of applying the coating liquid to the cylindrical body by using the coating device according to the first exemplary embodiment, and showing a state where the cylindrical body inserted into the coating liquid holding part is lowered to the vicinity of the lowermost portion;

FIG. 7 is a cross-sectional view showing a fourth step of applying the coating liquid to the cylindrical body by using the coating device according to the first exemplary embodiment, and showing a state where the cylindrical body is being moved upward in an up-down direction with respect to the coating liquid holding part;

FIG. 8 is a cross-sectional view showing a fifth step of applying the coating liquid to the cylindrical body by using the coating device according to the first exemplary embodiment, and showing a state where the cylindrical body is being further moved upward in the up-down direction with respect to the coating liquid holding part;

FIG. 9 is a cross-sectional view showing a sixth step of applying the coating liquid to the cylindrical body by using the coating device according to the first exemplary embodiment, and showing a state where the cylindrical body has been moved upward in the up-down direction with respect to the coating liquid holding part;

FIG. 10 is a cross-sectional view showing an outline of an overall configuration of a coating device according to a second exemplary embodiment, and is a diagram showing a state where the cylindrical body is being inserted and lowered into the coating liquid holding part;

FIG. 11 is a cross-sectional view showing the outline of the overall configuration of the coating device according to the second exemplary embodiment, and is a diagram showing a state where the cylindrical body has been moved upward in the up-down direction with respect to the coating liquid holding part; and

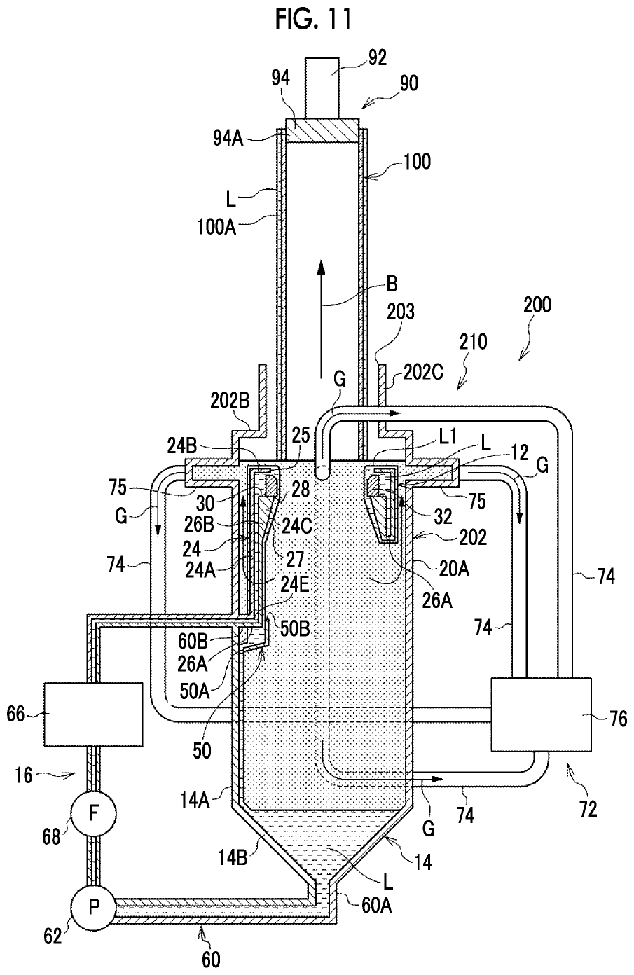

FIG. 12 is a diagram showing a measuring instrument for measuring solvent vapor concentration of the coating liquid in the coating device according to the first exemplary embodiment.

### DETAILED DESCRIPTION

Hereinafter, exemplary embodiments for carrying out the technique of the present disclosure will be described. In the following description, the direction indicated by an arrow UP appropriately shown in the drawings is defined as the upper side in an up-down direction of a device. In each drawing, components that are less relevant to the technique of the present disclosure are not shown.

### First Exemplary Embodiment

### Overall Configuration of Coating Device

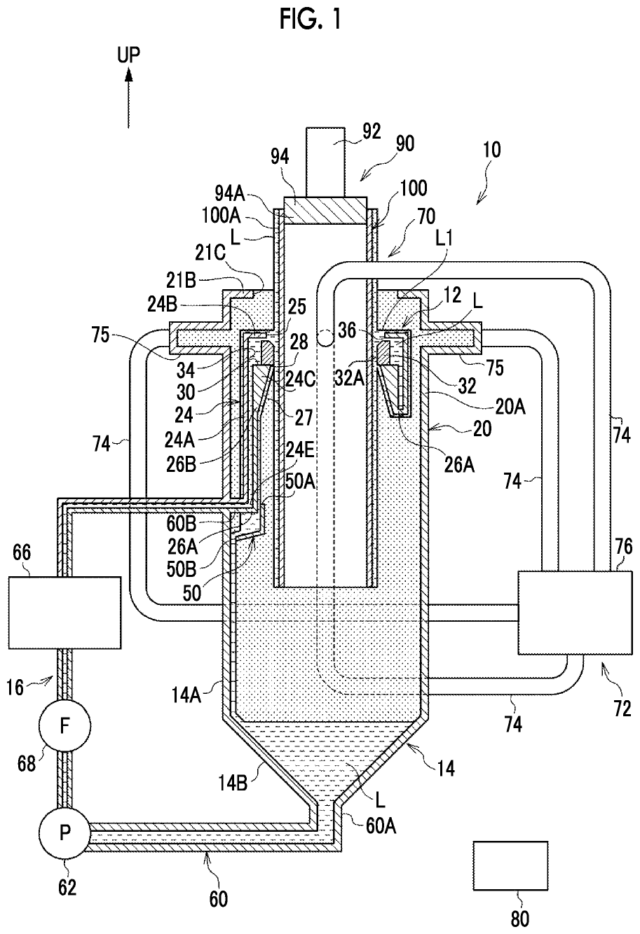

In FIG. 1, an example of a coating device 10 according to a first exemplary embodiment is shown in a cross-sectional view.

As shown in FIG. 1, the coating device 10 is a device for applying a coating liquid L to an outer peripheral surface 100A of a cylindrical body 100 as an example of a base material. The coating device 10 includes a coating liquid holding part 12 in which the coating liquid Lis held, and an annular body 32 disposed inside the coating liquid holding part 12. Further, the coating device 10 includes a container 20 having a tubular shape and surrounding the coating liquid holding part 12, and a moving device 90 that relatively moves the cylindrical body 100 in an up-down direction with respect to the coating liquid holding part 12. Further, the coating device 10 includes a vapor concentration holding part 70 that holds solvent vapor concentration of the coating liquid L in a region determined from a liquid level L1 in the coating liquid holding part 12.

The vapor concentration holding part 70 includes a circulation part 16 that supplies the coating liquid L to the coating liquid holding part 12, a storage part 14 that receives the coating liquid L flowing down from the coating liquid holding part 12, and a suction device 72 that sucks gas from the inside of the container 20. The circulation part 16 is an example of a coating liquid supply part, and the storage part 14 is an example of a coating liquid receiving part. The suction device 72 is an example of a sealing unit that seals portions other than an opening 21C (described later) of the container 20. Further, the suction device 72 is an example of a releasing unit that releases the sealing of the portions other than the opening 21C of the container 20, and an example of a suction part.

### Cylindrical Body

The cylindrical body 100 is, for example, a cylindrical member made of metal or a member obtained by winding an endless belt-shaped member made of metal around a cylindrical core material. The cylindrical member or the endless belt-shaped member configuring the cylindrical body 100 is, for example, a photoreceptor substrate or the like for an electrophotography. In the first exemplary embodiment, the coating liquid L is applied to the cylindrical member or the endless belt-shaped member configuring the cylindrical body 100 by the coating device 10.

### Coating Liquid

The coating liquid L is a coating liquid for forming a protective layer on the outer peripheral surface of the cylindrical body 100. The coating liquid L contains a solvent. For example, in a case where a photoreceptor substrate for an electrophotography is used as the cylindrical body 100, the coating liquid L may be a liquid or the like that contains a photosensitive material in a solvent. By using a liquid containing a photosensitive material as the coating liquid L, it is possible to manufacture a photoreceptor for an electrophotography. The boiling point of the solvent that is contained in the coating liquid Lis preferably, for example, 70° C. or higher and 110° C. or lower, more preferably 73° C. or higher and 105° C. or lower, and further preferably 75° C. or higher and 100° C. or lower. As the solvent that is contained in the coating liquid L, for example, an alcohol-based solvent (for example, ethanol or 1-propanol) or the like can be given. The boiling point of ethanol is 78.37° C., and the boiling point of 1-propanol is 97° C.

### Container

As shown in FIG. 1, the container 20 is configured with a cylindrical member, and is disposed such that an axial direction of the container 20 is in the up-down direction. As an example, for example, the container 20 includes a cylindrical portion 20A disposed along the up-down direction. The inner diameter of the cylindrical portion 20A is larger than the outer shape of the coating liquid holding part 12. The cylindrical portion 20A is disposed so as to surround the coating liquid holding part 12.

An upper wall portion 21B extending inward in a radial direction is provided at the upper end portion of the cylindrical portion 20A, and a circular opening 21C is formed in the upper wall portion 21B. The inner diameter of the opening 21C is larger than the outer diameter of the cylindrical body 100. A configuration is made such that the cylindrical body 100 is inserted into the opening 21C of the upper wall portion 21B from the upper side and the cylindrical body 100 penetrates the opening 21C of the upper wall portion 21B in the axial direction.

### Coating Liquid Holding Part

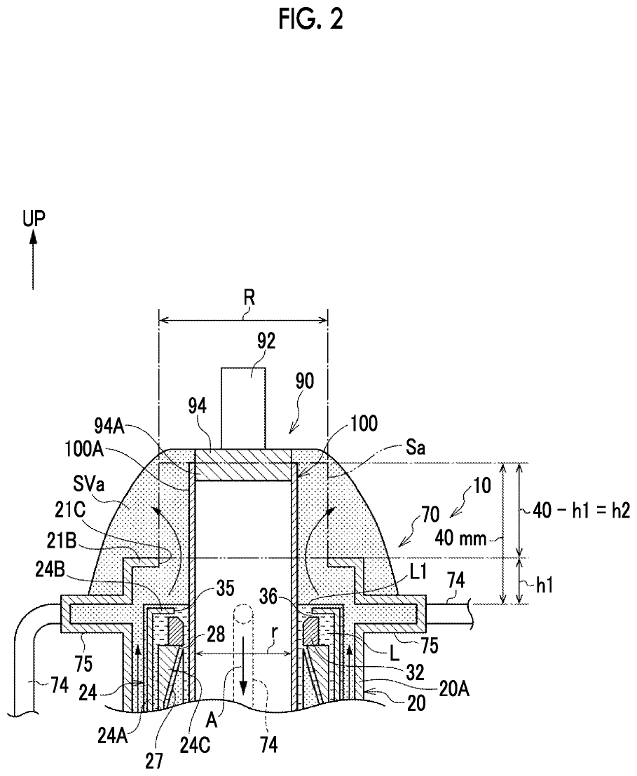

As shown in FIGS. 1 and 2, the coating liquid holding part 12 has a function of holding the coating liquid L that is supplied from the circulation part 16. The coating liquid holding part 12 includes a case 24. The case 24 includes a cylindrical portion 24A, an upper wall portion 24B bent inward in the radial direction from an upper end portion of the cylindrical portion 24A, and a block portion 24C disposed on the lower portion side of the cylindrical portion 24A.

When viewed in the cross section shown in FIG. 1, the cylindrical portion 24A is made such that the length in the up-down direction on one side (the left side in FIG. 1) in the circumferential direction is longer than the length in the up-down direction on the other side (the right side in FIG. 1) in the circumferential direction. That is, one side (the left side in FIG. 1) in the circumferential direction of the cylindrical portion 24A extends downward further than the other side (the right side in FIG. 1) in the circumferential direction of the cylindrical portion 24A. Although illustration is omitted, the cylindrical portion 24A is formed such that the length in the up-down direction is gradually shortened from one side (the left side in FIG. 1) in the circumferential direction toward the other side (the right side in FIG. 1) in the circumferential direction. A lower end portion of the cylindrical portion 24A is connected to a bottom wall portion 26A (described later) extending inward in the radial direction.

An inflow port 24E through which the coating liquid L flows in is provided at the lower portion on one side (the right side in FIG. 1) in the circumferential direction of the cylindrical portion 24A.

An upper opening portion 25 having a circular shape is provided in the upper wall portion 24B (refer to FIG. 2). The inner diameter of the upper opening portion 25 is larger than the outer diameter of the cylindrical body 100. A configuration is made such that the cylindrical body 100 penetrates the upper opening portion 25 of the upper wall portion 24B in the axial direction.

The block portion 24C includes a bottom wall portion 26A connected to a lower end portion of the cylindrical portion 24A, and a tubular inner side wall portion 26B extending upward from the radially inner end portion of the bottom wall portion 26A (refer to FIG. 1). An inclined portion 27 disposed to have an upward slope toward the inner side in the radial direction is formed on the upper portion side of the inner side wall portion 26B. A lower opening portion 28 having a circular shape is provided in the upper end portion of the inclined portion 27 of the inner side wall portion 26B. The inner diameter of the lower opening portion 28 is larger than the outer diameter of the cylindrical body 100. Further, the inner diameter of the lower opening portion 28 is smaller than the inner diameter of the upper opening portion 25. A configuration is made such that the cylindrical body 100 penetrates the lower opening portion 28 of the block portion 24C in the axial direction.

Although illustration is omitted, the bottom wall portion 26A is disposed along the lower end portion of the cylindrical portion 24A and formed obliquely with respect to the axial direction. In this way, the coating liquid L flowing in from the inflow port 24E flows in the circumferential direction of the cylindrical portion 24A along the bottom wall portion 26A formed obliquely with respect to the axial direction, and flows to the upper side of the cylindrical portion 24A.

The coating liquid holding part 12 is supported on the upper portion side in the up-down direction inside the container 20 by a supporting portion (not shown).

The case 24 includes the cylindrical portion 24A, the upper wall portion 24B, and the block portion 24C, so that the upper side of the block portion 24C is open inward in the radial direction. An installation surface 30 on which the annular body 32 is disposed so as to be relatively displaceable is provided at the upper portion of the block portion 24C. The installation surface 30 has a function of supporting the annular body 32 so as to be relatively displaceable. The installation surface 30 has a planar shape and is disposed along the horizontal direction.

A flow path 34 through which the coating liquid L flows is provided between the cylindrical portion 24A and the block portion 24C and between the cylindrical portion 24A and the annular body 32 inside the case 24. The end portion of the flow path 34 on the upstream side in a flow direction of the coating liquid L is connected to the inflow port 24E.

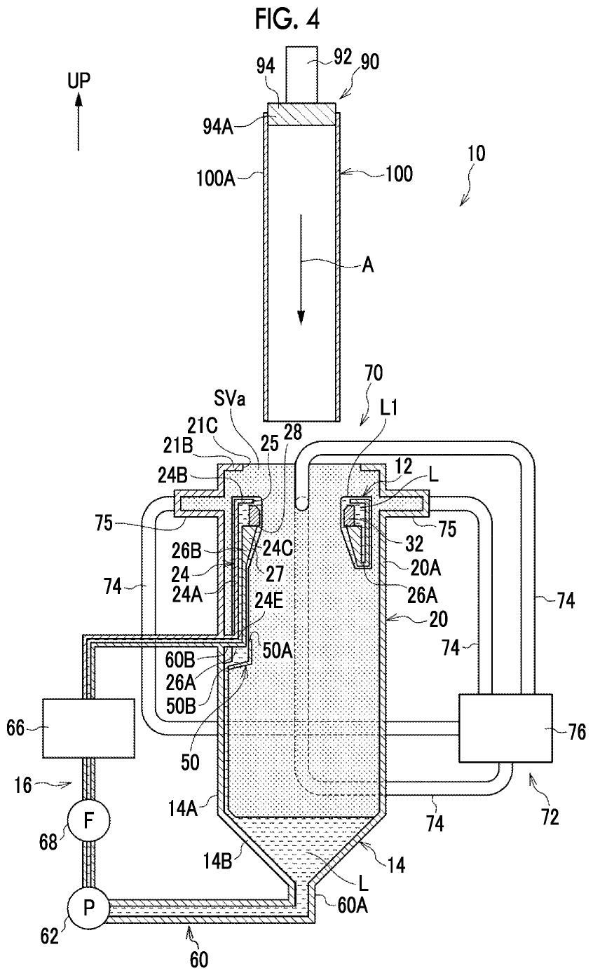

The cylindrical body 100 penetrates the upper opening portion 25 and the lower opening portion 28 of the coating liquid holding part 12, and the cylindrical body 100 moves relative to the coating liquid holding part 12 in the up-down direction by the moving device 90 (refer to FIGS. 4 to 9). The installation surface 30 is disposed in a direction intersecting the direction of the relative movement of the cylindrical body 100.

### Annular Body

As shown in FIG. 1, the annular body 32 is provided in an open portion on the inner side in the radial direction of the case 24. The annular body 32 is disposed on the upper side of the installation surface 30 of the upper portion of the block portion 24C in the case 24. The annular body 32 is installed so as to be relatively displaceable along the installation surface 30 of the upper portion of the block portion 24C.

The inner diameter of the annular body 32 is larger than the outer diameter of the cylindrical body 100. A configuration is made such that the cylindrical body 100 penetrates the annular body 32 in the axial direction. That is, the cylindrical body 100 penetrating the upper opening portion 25 and the lower opening portion 28 of the coating liquid holding part 12 penetrates the annular body 32. As an example, the inner diameter of the annular body 32 is smaller than the inner diameter of the lower opening portion 28. An inner peripheral surface 32A side of the annular body 32 is exposed to a region through which the cylindrical body 100 penetrates (refer to FIG. 2).

As an example, the annular body 32 is disposed on the installation surface 30 of the upper portion of the block portion 24C in a state where the coating liquid Lis interposed between the annular body 32 and the installation surface 30. The annular body 32 is made to be movable (in the first exemplary embodiment, slidable) with respect to the installation surface 30 in a state where the coating liquid Lis interposed between the annular body 32 and the installation surface 30. In the first exemplary embodiment, a driving unit that directly drives the annular body 32 is not provided, and the annular body 32 is made to autonomously slide relative to the installation surface 30.

As shown in FIG. 2, a slit-shaped discharge portion 36 is provided along the circumferential direction between the upper opening portion 25 of the upper wall portion 24B of the coating liquid holding part 12 and the annular body 32. The coating liquid L is discharged from the discharge portion 36. That is, the discharge portion 36 faces the region of the coating liquid holding part 12, through which the cylindrical body 100 penetrates, and the coating liquid L is discharged toward the cylindrical body 100 side. The coating liquid L discharged from the discharge portion 36 flows from the upper opening portion 25 toward the upper surface side of the upper wall portion 24B to overflow, and flows downward between the annular body 32 and the outer peripheral surface 100A of the cylindrical body 100. That is, the coating liquid L held by the coating liquid holding part 12 flows in from the upper side and flows out from the lower side with relative movement between the annular body 32 and the cylindrical body 100.

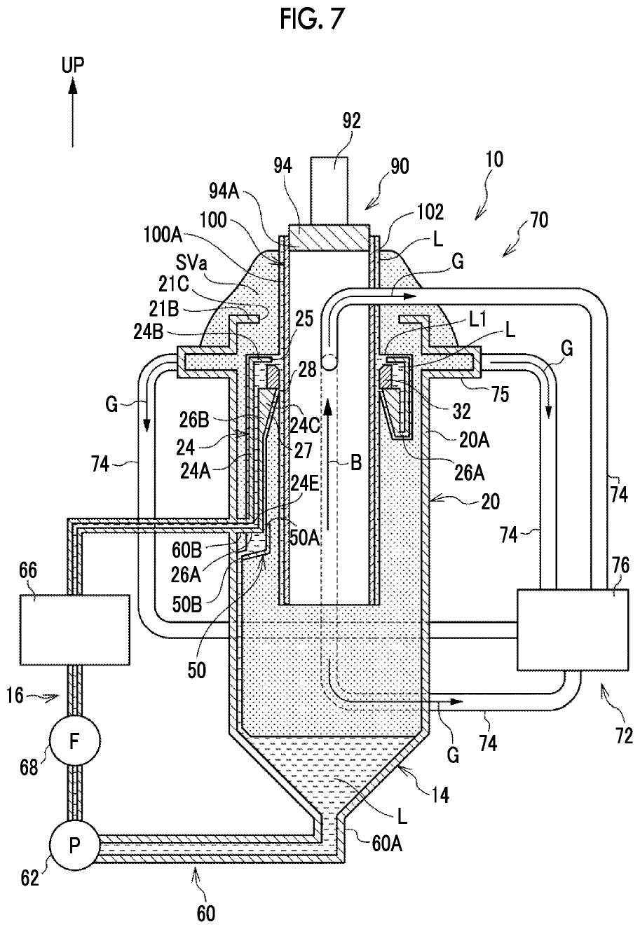

As shown in FIG. 1, in the coating device 10, the coating liquid L is applied to the outer peripheral surface 100A of the cylindrical body 100 by relatively moving the cylindrical body 100 upward in the up-down direction with respect to the coating liquid holding part 12 (refer to FIGS. 7 to 9). In the coating liquid holding part 12, the coating liquid L flows between the outer peripheral surface 100A of the cylindrical body 100 and the inner peripheral surface 32A of the annular body 32, and the annular body 32 is displaced relative to the installation surface 30 by the pressure due to the flow of the coating liquid L. At this time, the annular body 32 is displaced relative to the installation surface 30 such that the gap between the outer peripheral surface 100A of the cylindrical body 100 and the inner peripheral surface 32A of the annular body 32 becomes uniform along the circumferential direction.

Further, as shown in FIG. 1, in the coating device 10, a wall portion 50 is provided on the lower side of the coating liquid holding part 12 inside the container 20. An opening portion 50A through which the cylindrical body 100 penetrates is provided in the wall portion 50. Further, a hole portion 50B disposed at a position adjacent to the inner wall surface of the container 20 is provided in a lower end portion in an oblique direction of the wall portion 50. In this way, the coating liquid L flows down along the inner wall surface of the container 20 from the hole portion 50B of the wall portion 50 and is collected in the storage part 14.

### Moving Device

As shown in FIG. 1, the moving device 90 has a function of relatively moving the cylindrical body 100 in the up-down direction with respect to the coating liquid holding part 12. As an example, the moving device 90 moves the cylindrical body 100 in the up-down direction without changing the position in the up-down direction of the coating liquid holding part 12. The moving device 90 is configured with, for example, a rack-and-pinion, an actuator, a hydraulic cylinder, or the like. As an example, the moving device 90 is configured with a hydraulic cylinder, and has a rod 92 that can advance and retreat in the up-down direction from a cylinder main body (not shown). A holder 94 is provided at the tip of the rod 92 to hold an upper portion in the axial direction of the cylindrical body 100 from the inside (that is, from the inner peripheral surface side). The holder 94 has a plurality of gripping surfaces (not shown) whose diameters are expanded or reduced in the radial direction, and the diameters of the plurality of gripping surfaces are expanded in the radial direction, so that the cylindrical body 100 is gripped from the inner peripheral surface side.

In the moving device 90, the rod 92 advances and retreats with respect to the cylinder main body, so that the cylindrical body 100 moves in the up-down direction with respect to the coating liquid holding part 12. The operation of moving the cylindrical body 100 in the up-down direction by the moving device 90 will be described later.

### Configuration of Vapor Concentration Holding Part

As shown in FIG. 1, the vapor concentration holding part 70 includes the storage part 14, the circulation part 16, and the suction device 72, as described above. The vapor concentration holding part 70 circulates the coating liquid L from the storage part 14 to the coating liquid holding part 12 by the circulation part 16. The vapor concentration holding part 70 includes a control unit 80 that controls the operations of the circulation part 16 and the suction device 72. Further, the control unit 80 controls the operation of each part of the coating device 10, such as the operation of the moving device 90. The vapor concentration holding part 70 causes the control unit 80 to stop the suction of the solvent-containing gas from the inside of the container 20 by the suction device 72 in a state where the coating liquid Lis circulated, thereby sealing the portions other than the opening 21C of the container 20. Further, the vapor concentration holding part 70 causes the control unit 80 to suck the solvent-containing gas from the inside of the container 20 by the suction device 72 in a state where the coating liquid Lis circulated, thereby releasing sealing of the portions other than the opening 21C of the container 20.

### Storage Part

As shown in FIG. 1, the storage part 14 is provided at a lower portion in the up-down direction of the container 20. As an example, the storage part 14 is connected to the lower end portion of the cylindrical portion 20A of the container 20.

More specifically, the storage part 14 includes a cylindrical portion 14A connected to the cylindrical portion 20A, and a recess portion 14B disposed at the lower portion of the cylindrical portion 14A and recessed to have a valley-shaped bottom surface. In the present exemplary embodiment, the bottom surface of the recess portion 14B has an inverted conical shape in which the inner diameter gradually decreases toward the lower side.

The recess portion 14B has a bottom surface inclined to have a downward slope from the cylindrical portion 14A side toward the central portion in the radial direction, and the central portion of the recess portion 14B is the lowermost portion. The coating liquid L flowing down from the coating liquid holding part 12 side is collected in the recess portion 14B of the storage part 14.

### Circulation Part

As shown in FIG. 1, the circulation part 16 circulates the coating liquid L inside the storage part 14 to the coating liquid holding part 12. The circulation part 16 includes a supply pipe 60 that supplies the coating liquid L inside the storage part 14 to the coating liquid holding part 12, and a pump 62 provided in the middle of the supply pipe 60. The pump 62 transfers the coating liquid L in the supply pipe 60 from the storage part 14 side to the coating liquid holding part 12 side.

An upstream-side end portion 60A in the flow direction of the coating liquid L of the supply pipe 60 is connected to the lower portion of the storage part 14. In the first exemplary embodiment, the upstream-side end portion 60A of the supply pipe 60 is connected to the central portion which is the lowermost portion of the recess portion 14B. Further, a downstream-side end portion 60B in the flow direction of the coating liquid L of the supply pipe 60 penetrates the container 20 and is connected to the inflow port 24E of the coating liquid holding part 12. In this way, the coating liquid L flowing through the supply pipe 60 is supplied to the flow path 34 from the inflow port 24E. There is a case where the upstream side or the downstream side in the flow direction of the coating liquid L is simply referred to as the “upstream side” or the “downstream side” with the expression “in the flow direction of the coating liquid L” omitted.

Further, a viscosity measuring unit 66 that measures the viscosity of the coating liquid L is provided on the downstream side of the pump 62 in the flow direction of the coating liquid L in the middle of the supply pipe 60. Further, a filter 68 for removing foreign matter contained in the coating liquid Lis provided on the upstream side of the viscosity measuring unit 66 in the flow direction of the coating liquid L in the middle of the supply pipe 60.

In the coating device 10, the coating liquid L in the storage part 14 is supplied to the coating liquid holding part 12 through the supply pipe 60 by driving the pump 62 of the circulation part 16. In the coating liquid holding part 12, the coating liquid L is applied to the outer peripheral surface 100A of the cylindrical body 100, and the coating liquid L flowing down along the outer peripheral surface 100A of the cylindrical body 100 is collected in the storage part 14. Then, the coating liquid L in the storage part 14 is supplied to the coating liquid holding part 12 through the supply pipe 60. Therefore, the coating liquid L in the storage part 14 is circulated to the coating liquid holding part 12 by the circulation part 16.

### Suction Device

As shown in FIG. 1, the suction device 72 is connected to the container 20 and has a function of sucking a gas inside the container 20. More specifically, the suction device 72 includes a plurality of ducts 74 connected to the container 20, and a gas suction machine 76 provided in the plurality of ducts 74. The number of ducts 74 may be one. However, the number of ducts 74 is preferably, for example, two or more, and more preferably three or more. In the first exemplary embodiment, there are four ducts 74. The duct 74 is an example of a ventilation pipe.

The duct 74 is configured with, for example, a flexible tube. The four ducts 74 are connected to the container 20 at positions equal to or lower than the height of the liquid level L1 in the coating liquid L inside the coating liquid holding part 12. As an example, the cylindrical portion 20A of the container 20 is provided with connection pipes 75 disposed at four locations at equal intervals along the circumferential direction. The four connection pipes 75 protrude radially outward from the cylindrical portion 20A, and each of the ducts 74 is connected to each of the four connection pipes 75. That is, the connection pipes 75 are connected to the positions of three or more locations (four locations in the first exemplary embodiment) at equal intervals along the circumferential direction of the container 20.

The gas suction machine 76 is provided at the end portions of the four ducts 74 on the side opposite to the container 20, and is connected to each of the four ducts 74. The gas suction machine 76 sucks the air in the four ducts 74, and for example, an ejector, a suction fan, or the like can be used. In the first exemplary embodiment, an ejector is used as the gas suction machine 76.

### Function of Vapor Concentration Holding Part

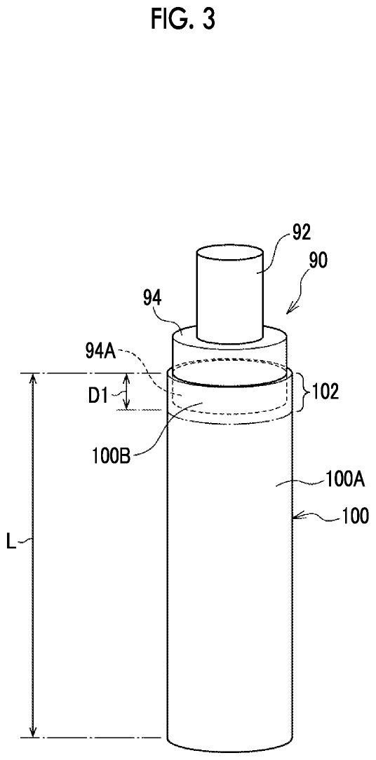

As shown in FIG. 2, the vapor concentration holding part 70 has a function of holding the solvent vapor concentration of the solvent contained in the coating liquid L in a region Sa determined from the liquid level L1 in the coating liquid holding part 12 at a value equal to or higher than a determined value until a determined range 102 (refer to FIG. 3) of an upper portion in the axial direction of the cylindrical body 100 passes through the region Sa. Here, the liquid level L1 in the coating liquid holding part 12 is the liquid level of the coating liquid L on the upper surface side of the upper wall portion 24B in a state where the coating liquid L discharged from the discharge portion 36 flows from the upper opening portion 25 toward the upper surface side of the upper wall portion 24B and overflows.

As shown in FIG. 3, the determined range 102 of the upper portion in the axial direction of the cylindrical body 100 is the range of a distance DI from the upper end of the cylindrical body 100. In the first exemplary embodiment, the distance DI is 20 mm. That is, the determined range 102 of the upper portion in the axial direction of the cylindrical body 100 is the range of the distance of 20 mm from the upper end of the cylindrical body 100.

As shown in FIG. 2, the region Sa determined from the liquid level L1 in the coating liquid holding part 12 is a region located above the opening 21C of the container 20 and having the height of 40 mm or lower from the liquid level L1 in the coating liquid holding part 12. More specifically, when the height from the liquid level L1 in the coating liquid holding part 12 to the upper surface of the edge portion of the opening 21C of the container 20 is h1, the region Sa determined from the liquid level L1 in the coating liquid holding part 12 is a region located above the height h1 from the liquid level L1 and having the height of 40 mm or lower from the liquid level L1.

As shown in FIGS. 2 and 3, the inner diameter of the cylindrical body 100 is set to be r, the length in the axial direction of the cylindrical body 100 is set to be L, the internal volume of the cylindrical body 100 is set to be V, the inner diameter of the opening 21C of the container 20 is set to be R, and the volume of an insertion portion 94A of the holder 94 into the cylindrical body 100 is set to be Vc. Further, the difference between the position of the height of 40 mm from the liquid level L1 in the coating liquid holding part 12 and the height h1 from the liquid level L1 in the coating liquid holding part 12 to the upper surface of the edge portion of the opening 21C of the container 20 is set to be h2. That is, the height h2 is the height from the upper surface of the edge portion of the opening 21C of the container 20 to the position of the height of 40 mm from the liquid level L1 in the coating liquid holding part 12. Further, when the volume of the region Sa located above the opening 21C of the container 20 and having the height of 40 mm from the liquid level L1 in the coating liquid holding part 12 is set to be S, the coating device 10 is configured to satisfy the following expressions.

$$V - Vc > S$$

$$V = {( r / 2 )}^{2} \times π \times L$$

$$S = {( R / 2 )}^{2} \times π \times h 2$$

$$h 2 = 40 - h 1$$

An upper portion 100B in the axial direction of the cylindrical body 100 is held by the holder 94 from the inside, so that the upper end of the cylindrical body 100 is sealed. The vapor concentration holding part 70 is a part for moving solvent vapor SVa of the coating liquid L in the container 20 to a range that includes the region Sa above the opening 21C of the container 20 when the cylindrical body 100 whose upper end is sealed is moved from top to bottom (in the direction of an arrow A) and set in the coating liquid holding part 12 (refer to FIGS. 4 to 6).

The vapor concentration holding part 70 sets a retention time (that is, a standby time) from setting of the cylindrical body 100 to the coating liquid holding part 12 to the start of application of the coating liquid L to a time equal to or longer than a determined time. As an example, the retention time from the setting of the cylindrical body 100 to the coating liquid holding part 12 to the start of application of the coating liquid L is preferably, for example, 2 seconds or longer, more preferably 3 seconds or longer, and further preferably 4 seconds or longer.

The vapor concentration holding part 70 may block the suction of the gas inside the container 20 by the suction device 72 until the determined range 102 (refer to FIG. 3) of the upper portion in the axial direction of the cylindrical body 100 passes through the region Sa. That is, when the cylindrical body 100 is moved upward in the up-down direction, the vapor concentration holding part 70 may disable the operation of the suction device 72 until the determined range 102 of the upper portion in the axial direction of the cylindrical body 100 passes through the region Sa. In this way, the vapor concentration holding part 70 holds the solvent vapor concentration (concentration of the solvent vapor SVa) in the region Sa at 5000 ppm or higher until the determined range 102 of the upper portion in the axial direction of the cylindrical body 100 passes through the region Sa.

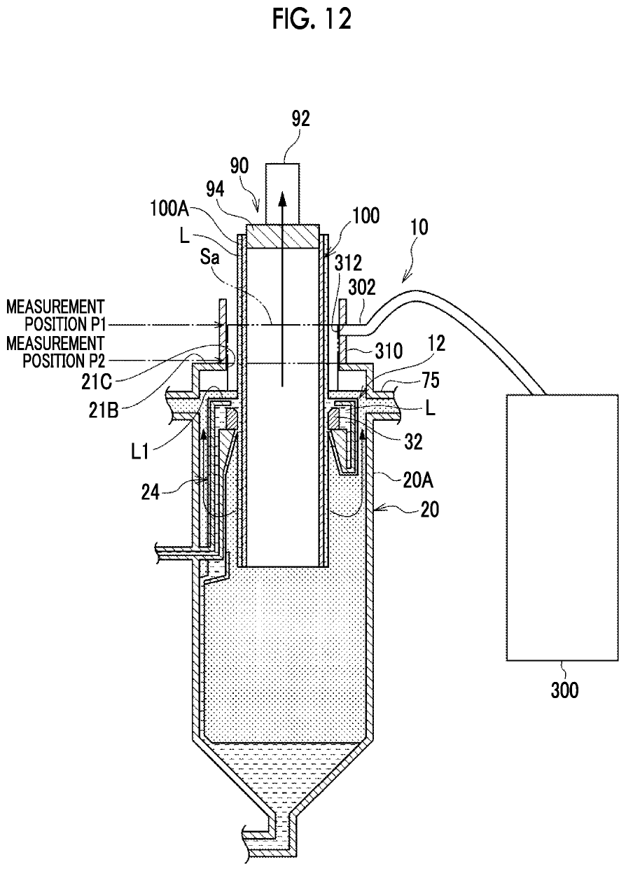

Here, a method for measuring the concentration of the solvent vapor SVa will be described. As shown in FIG. 12, for example, a measuring instrument 300 such as “XP-3360II” manufactured by New Cosmos Electric Co., Ltd. is used to directly measure the solvent vapor concentration during the coating operation of the coating device 10. Specifically, the solvent vapor concentration during the coating operation can be directly measured in the solvent measurement mode of the measuring instrument 300 by installing a cylindrical hood 310 above the edge portion of the opening 21C of the container 20 of the coating device 10 and inserting a suction port 302 extending from the measuring instrument 300 into a hole 312 provided in the hood 310. The measuring instrument 300 is a measuring instrument for a high-concentration volatile organic compound (VOC). In the present exemplary embodiment, the solvent vapor concentration is measured at a plurality of positions that include a measurement position P1 at an upper limit of the region Sa and a measurement position P2 at a lower end portion of the hood 310.

Further, in a management method, a setting value that satisfies the condition of the solvent vapor concentration is extracted in advance, and during production, only monitoring is performs, and as a result, in a case where a condition is not met, the production is stopped, and control to review the setting value is performed. The supply amount of the coating liquid L may be feedback-controlled while measuring the concentration of the solvent vapor SVa with the measuring instrument 300.

Further, the vapor concentration holding part 70 holds the solvent vapor concentration inside the container 20 at 10000 ppm or higher before the cylindrical body 100 penetrates the coating liquid holding part 12 as a pre-step of applying the coating liquid L (refer to FIG. 4). The concentration of the solvent vapor SVa inside the container 20 is measured by inserting the suction port 302 of the measuring instrument 300 through the hole 312 provided in the hood 310 in the same manner as described above.

In a case where the vapor concentration holding part 70 can hold the solvent vapor concentration in the region Sa at 5000 ppm or higher until the determined range 102 of the upper portion in the axial direction of the cylindrical body 100 passes through the region Sa, the vapor concentration holding part 70 may suck the gas inside the container 20 by the suction device 72 with the start of movement of the cylindrical body 100 upward in the up-down direction with respect to the coating liquid holding part 12.

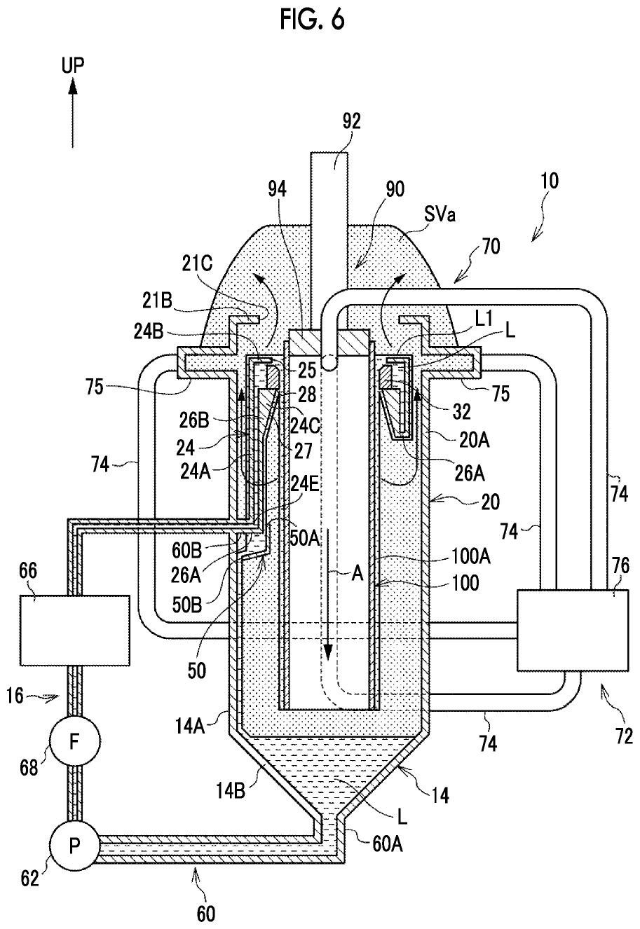

In the first exemplary embodiment, when the cylindrical body 100 is moved upward in the up-down direction, the vapor concentration holding part 70 stops the operation of the suction device 72 so as not to suck the gas inside the container 20, until the determined range 102 of the upper portion in the axial direction of the cylindrical body 100 passes through the region Sa (refer to FIG. 6).

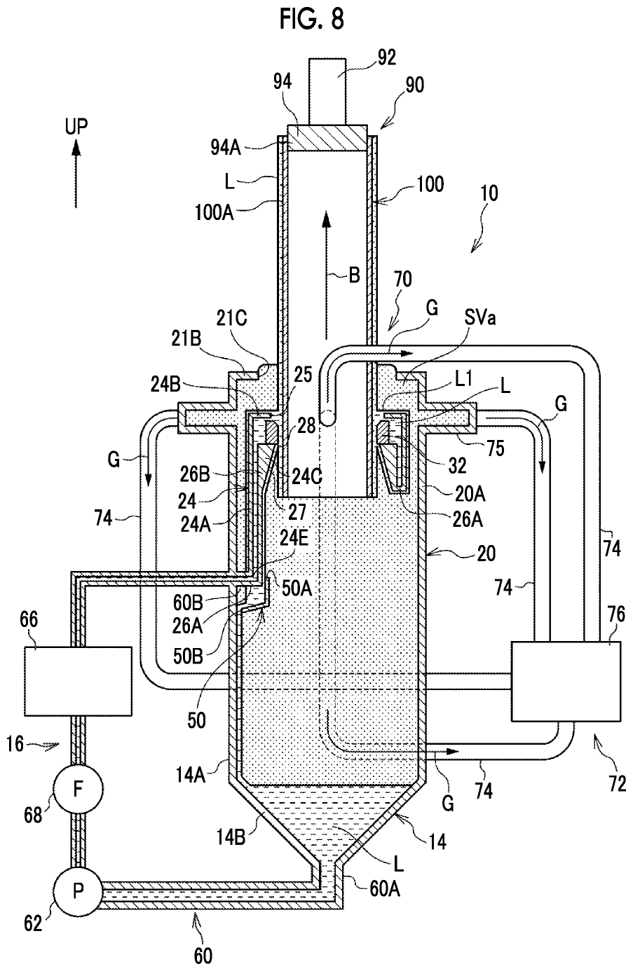

The vapor concentration holding part 70 operates the suction device 72 to suck the gas inside the container 20 after the determined range 102 of the upper portion in the axial direction of the cylindrical body 100 has passed through the region Sa (refer to FIG. 8 and the like).

### Operation and Effect

Next, the operation and effect of the present exemplary embodiment will be described.

The steps of applying the coating liquid L to the outer peripheral surface 100A of the cylindrical body 100 by the coating device 10 will be described in order.

As shown in FIG. 4, the vapor concentration holding part 70 holds the solvent vapor concentration inside the container 20 at 10000 ppm or higher before the cylindrical body 100 penetrates the coating liquid holding part 12 as a pre-step of applying the coating liquid L to the cylindrical body 100. For example, the coating liquid L is supplied to the coating liquid holding part 12 and circulated by the circulation part 16. The vapor concentration holding part 70 does not operate the suction device 72 (that is, does not suck the gas from the inside of the container 20) in a state where the coating liquid L is circulated, thereby sealing the portions other than the opening 21C of the container 20. In this way, the vapor concentration holding part 70 holds the solvent vapor concentration inside the container 20 at 10000 ppm or higher by filling the inside of the container 20 with the solvent vapor SVa.

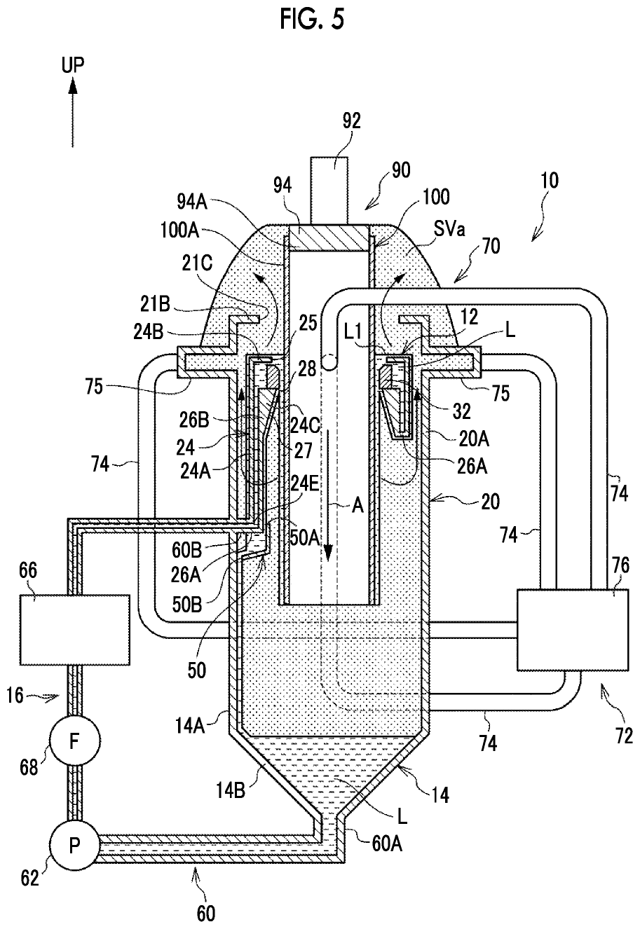

As shown in FIG. 5, the cylindrical body 100 is inserted downward (in the direction of the arrow A) in the up-down direction along the axial direction from above the coating liquid holding part 12 by the moving device 90 while the coating liquid L is supplied to the coating liquid holding part 12 by the circulation part 16 (that is, in a state where the coating liquid L is circulated). Then, as shown in FIG. 6, the cylindrical body 100 is set in the coating liquid holding part 12 by moving the cylindrical body 100 to the lowermost portion by the moving device 90. When the cylindrical body 100 reaches the lowermost portion, the upper portion in the axial direction of the cylindrical body 100 faces the coating liquid holding part 12. The vapor concentration holding part 70 is a part for moving the solvent vapor SVa of the coating liquid L in the container 20 to a range that includes the region Sa (refer to FIG. 2) above the opening 21C of the container 20 as shown by an arrow when the cylindrical body 100 whose upper end is sealed is moved from top to bottom (in the direction of the arrow A) and set in the coating liquid holding part 12.

The vapor concentration holding part 70 sets the retention time from the setting of the cylindrical body 100 to the coating liquid holding part 12 to the start of the coating of the coating liquid L to a time equal to or longer than a determined time (for example, three seconds). In this way, the vapor concentration holding part 70 holds the solvent vapor concentration in the region Sa above the opening 21C of the container 20 at a high concentration close to 10000 ppm.

The coating liquid L is filled between the annular body 32 of the coating liquid holding part 12 and the outer peripheral surface 100A of the cylindrical body 100 by supplying the coating liquid L to the coating liquid holding part 12 by the circulation part 16 (refer to FIG. 1) in a state where the cylindrical body 100 is set in the coating liquid holding part 12. Then, the cylindrical body 100 is moved upward (in the direction of an arrow B) in the up-down direction by the moving device 90 while the coating liquid L is supplied to the coating liquid holding part 12 by the circulation part 16. At this time, the coating liquid L overflows upward from the discharge portion 36 of the coating liquid holding part 12. Along with this, the coating liquid L flows downward from the lower opening portion 28 and is applied to the outer peripheral surface 100A of the cylindrical body 100 located above the upper opening portion 25. In this way, a coating layer by the coating liquid L is formed on the outer peripheral surface 100A of the cylindrical body 100.

The control unit 80 of the vapor concentration holding part 70 does not operate the suction device 72 and does not suck the gas inside the container 20 until the determined range 102 (refer to FIG. 3) of the upper portion in the axial direction of the cylindrical body 100 passes through the region Sa when the cylindrical body 100 is moved upward (in the direction of the arrow B) in the up-down direction. In this way, the vapor concentration holding part 70 holds the solvent vapor concentration in the region Sa at 5000 ppm or higher until the determined range 102 of the upper portion in the axial direction of the cylindrical body 100 passes through the region Sa.

As shown in FIG. 7, the control unit 80 of the vapor concentration holding part 70 operates the suction device 72 to suck the gas inside the container 20 after the determined range 102 of the upper portion in the axial direction of the cylindrical body 100 has passed through the region Sa. In this way, the gas containing the solvent vapor SVa inside the container 20 is sucked in the direction of an arrow G through the duct 74.

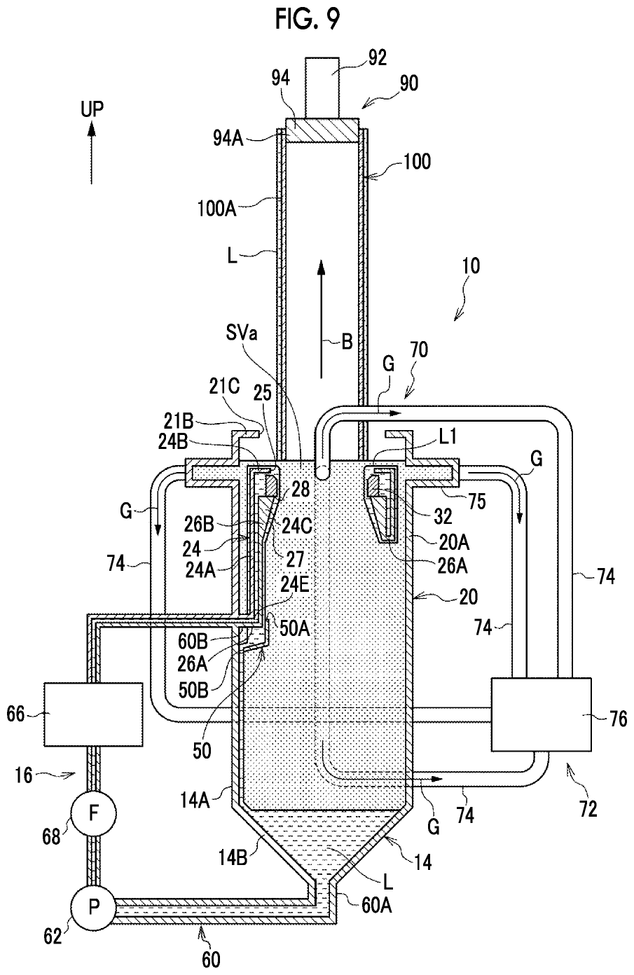

Then, as shown in FIGS. 8 and 9, the control unit 80 of the vapor concentration holding part 70 moves the cylindrical body 100 upward (in the direction of the arrow B) in the up-down direction to pull out the cylindrical body 100 from the coating liquid holding part 12 in a state where the suction device 72 is operated to suck the gas inside the container 20.

As described above, in the coating device 10, the coating liquid Lis applied to the outer peripheral surface 100A of the cylindrical body 100 by causing the cylindrical body 100 to penetrate the upper opening portion 25 and the lower opening portion 28 of the coating liquid holding part 12 and relatively moving the cylindrical body 100 upward (in the direction of the arrow B) in the up-down direction. The vapor concentration holding part 70 holds the solvent vapor concentration (that is, the concentration of the solvent vapor SVa of the solvent contained in the coating liquid L) in the region Sa at a value equal to or higher than a determined value (5000 ppm) until the determined range 102 (refer to FIG. 3) of the upper portion in the axial direction of the cylindrical body 100 passes through the region Sa (refer to FIG. 2) determined from the liquid level L1 in the coating liquid holding part 12.

Therefore, in the coating device 10, local film thickness unevenness of the coating layer of the cylindrical body 100 may be suppressed compared to a case where the solvent vapor concentration of the coating liquid L in the region Sa is lower than a determined value (5000 ppm) until the determined range 102 of the upper portion in the axial direction of the cylindrical body 100 passes through the region Sa determined from the liquid level L1 in the coating liquid holding part 12.

In general, in a case where the coating liquid L is applied to the outer peripheral surface 100A of the cylindrical body 100 to form a coating layer, when uneven drying of the coating liquid L occurs locally, there is a case where local film thickness unevenness called cissing occurs. Therefore, the faster the natural drying speed of the coating liquid Lis, the more easily the local film thickness unevenness of the coating layer occurs. In particular, in a coating device that applies the coating liquid L by moving the cylindrical body 100 upward along the axial direction, the local film thickness unevenness of the coating layer tends to occur at the upper end portion in the axial direction of the cylindrical body 100. Here, the local film thickness unevenness of the coating layer of the cylindrical body 100 refers to a state where a circular or elliptical thin film portion having a diameter or major axis length of 1 mm or longer and 5 mm or shorter occurs. Further, the film thickness difference of the film thickness unevenness refers to a portion having a film thickness difference of 1 μm or more from a non-occurrence portion on the same circumference of the cylindrical body 100.

In contrast, in the coating device 10 of the first exemplary embodiment, the vapor concentration holding part 70 holds the solvent vapor concentration in the region Sa at a value equal to or higher than a determined value (for example, 5000 ppm) until the determined range 102 of the upper portion in the axial direction of the cylindrical body 100 passes through the region Sa determined from the liquid level L1 in the coating liquid holding part 12. Therefore, when the determined range 102 of the upper portion in the axial direction of the cylindrical body 100 passes through the region Sa, the solvent vapor concentration is held at a high level, so that the local film thickness unevenness of the coating layer of the cylindrical body 100 may be suppressed.

Further, in the coating device 10, the coating liquid L is a coating liquid for forming a protective layer on the outer peripheral surface 100A of the cylindrical body 100. The vapor concentration holding part 70 holds the solvent vapor concentration (that is, the concentration of the solvent vapor SVa of the coating liquid L) in the region Sa at 5000 ppm or higher until the determined range 102 of the upper portion in the axial direction of the cylindrical body 100 passes through the region Sa. Therefore, in the coating device 10, the local film thickness unevenness of the protective layer of the cylindrical body 100 may be suppressed compared to a case where the solvent vapor concentration in the region Sa is lower than 5000 ppm until the determined range 102 of the upper portion in the axial direction of the cylindrical body 100 passes through the region Sa determined from the liquid level L1 in the coating liquid holding part 12.

Further, in the coating device 10, the coating liquid L whose solvent has a boiling point of 70° C. or higher and 110° C. or lower is used. Therefore, in the coating device 10, compared to a case of using a coating liquid in which the boiling point of a solvent is lower than 70° C. or higher than 110° C., the solvent vapor concentration in the region Sa may be adjusted to 5000 ppm or higher until the determined range 102 of the upper portion in the axial direction of the cylindrical body 100 passes through the region Sa.

Further, in the coating device 10, the vapor concentration holding part 70 holds the solvent vapor concentration inside the container 20 at 10000 ppm or higher before the cylindrical body 100 penetrates the coating liquid holding part 12 as a pre-step of applying the coating liquid L. Therefore, in the coating device 10, compared to a case where the solvent vapor concentration inside the container before the cylindrical body 100 penetrates the coating liquid holding part is lower than 10000 ppm, the solvent vapor concentration in the region Sa may be held at 5000 ppm or higher until the determined range 102 of the upper portion in the axial direction of the cylindrical body 100 passes through the region Sa.

Further, in the coating device 10, the vapor concentration holding part 70 includes the circulation part 16 that supplies the coating liquid L to the coating liquid holding part 12, the storage part 14 that is provided in the container 20 to receive the coating liquid L flowing down from the coating liquid holding part 12, and the suction device 72 that sucks the gas inside the container 20. The suction device 72 seals the portions other than the opening 21C of the container 20 by blocking the suction of the gas inside the container 20. Further, the suction device 72 releases the sealing of the portions other than the opening 21C of the container 20 by sucking the gas inside the container 20. Therefore, in the coating device 10, the solvent vapor concentration in the region Sa may be easily adjusted compared to a case where the portions other than the opening of the container are not sealed.

Further, in the coating device 10, the suction device 72 is connected to the container 20 and sucks the gas inside the container 20. Therefore, in the coating device 10, the solvent vapor concentration in the region Sa may be easily adjusted compared to a case where the gas inside the container is not sucked.

Further, in the coating device 10, the suction device 72 includes the duct 74 connected to the container 20 at a position equal to or lower than the height of the liquid level L1 of the coating liquid L inside the coating liquid holding part 12, and the gas suction machine 76 provided in the duct 74. Therefore, in the coating device 10, the suction of the gas inside the container 20 may be easily controlled compared to a case where the duct is connected to the container at a position higher than the height of the liquid level of the coating liquid inside the coating liquid holding part.

Further, in the coating device 10, the container 20 has a cylindrical shape, and the ducts 74 are connected to the positions of three or more locations (four locations in the first exemplary embodiment) at equal intervals along the circumferential direction of the container 20. Therefore, in the coating device 10, the solvent vapor concentration in the region Sa may be easily adjusted compared to a case where the ducts are connected to the positions of two or less locations in the circumferential direction of the container.

Further, in the coating device 10, the vapor concentration holding part 70 blocks the suction of the gas inside the container 20 by the suction device 72 until the determined range 102 of the upper portion in the axial direction of the cylindrical body 100 passes through the region Sa. Therefore, in the coating device 10, the solvent vapor concentration in the region Sa may be easily adjusted compared to a case where the gas inside the container is sucked by the suction device when the determined range 102 of the upper portion in the axial direction of the cylindrical body 100 passes through the region.

Further, in the coating device 10, the vapor concentration holding part 70 sucks the gas inside the container 20 with the suction device 72 after the determined range 102 of the upper portion in the axial direction of the cylindrical body 100 has passed through the region Sa. In general, the inside of the container 20 is filled with the solvent vapor SVa from the coating liquid L contained in the storage part 14 on the lower portion side in the axial direction of the cylindrical body 100, and drying of the coating layer on the outer peripheral surface 100A of the cylindrical body 100 tends to be delayed. Further, the coating liquid L flows down along the outer peripheral surface 100A of the cylindrical body 100, so that film thickness unevenness of the coating layer tends to occur on the lower portion side in the axial direction of the cylindrical body 100. Therefore, the solvent vapor concentration inside the container 20 is reduced by sucking the gas inside the container 20 with the suction device 72.

Therefore, in the coating device 10, the occurrence of film thickness unevenness due to the flow-down of the coating liquid L may be suppressed on the lower portion side in the axial direction of the cylindrical body 100, compared to a case where the gas inside the container is not sucked after the determined range 102 of the upper portion in the axial direction of the cylindrical body 100 has passed through the region.

Further, the coating device 10 includes the holder 94 that holds the upper portion in the axial direction of the cylindrical body 100 from the inside. As shown in FIG. 2, the inner diameter of the cylindrical body 100 is set to be r, the length of the cylindrical body 100 is set to be L, the internal volume of the cylindrical body 100 is set to be V, the inner diameter of the opening 21C of the container 20 is set to be R, and the volume of the insertion portion 94A of the holder 94 into the cylindrical body 100 is set to be Vc. Further, the height from the liquid level L1 in the coating liquid holding part 12 to the upper surface of the edge portion of the opening 21C of the container 20 is set to be h1, and the difference between the position of the height of 40 mm from the liquid level L1 in the coating liquid holding part 12 and the height h1 is set to be h2. Further, the volume of the region Sa located above the opening 21C of the container 20 and having the height of 40 mm from the liquid level L1 in the coating liquid holding part 12 is set to be S. The vapor concentration holding part 70 is a part for moving the solvent vapor SVa of the coating liquid L in the container 20 to a range that includes the region Sa above the opening 21C of the container 20 when the cylindrical body 100 whose upper end is sealed is moved from top to bottom and set in the coating liquid holding part 12. Further, the retention time from the setting of the cylindrical body 100 to the coating liquid holding part 12 to the start of application of the coating liquid is set to be a time equal to or longer than a determined time (for example, three seconds). At this time, a configuration is made such that the following expressions are satisfied.

$$V - Vc > S$$

$$V = {( r / 2 )}^{2} \times π \times L$$

$$S = {( R / 2 )}^{2} \times π \times h 2$$

$$h 2 = 40 - h 1$$

In this way, by moving the solvent vapor SVa of the coating liquid L in the container 20 to a range that includes the region Sa above the opening 21C of the container 20 when the cylindrical body 100 whose upper end is sealed is moved from top to bottom and set in the coating liquid holding part 12, it is possible to hold the solvent vapor concentration in the region Sa at a value equal to or higher than a determined value (for example, 5000 ppm). Therefore, in the coating device 10, the local film thickness unevenness of the coating layer of the cylindrical body 100 may be suppressed in the configuration that satisfies the above expressions.

Further, in the coating device 10, the determined range 102 of the upper portion in the axial direction of the cylindrical body 100 is a range having the length of 20 mm from the upper end of the cylindrical body 100. Therefore, in the coating device 10, the local film thickness unevenness of the coating layer may be suppressed in the range 102 having the length of 20 mm from the upper end in the axial direction of the cylindrical body 100, compared to a case where the solvent vapor concentration in the region Sa is lower than a determined value.

Further, a method for manufacturing a photoreceptor is a method for manufacturing a photoreceptor by applying the coating liquid L to the outer peripheral surface 100A of the cylindrical body 100 by using the coating device 10, the method including: a step of applying the coating liquid to the cylindrical body 100 by causing the cylindrical body 100 to penetrate the coating liquid holding part 12 and relatively moving the cylindrical body 100 upward in the up-down direction with respect to the coating liquid holding part 12. In the above step, the coating liquid L is applied to the outer peripheral surface 100A of the cylindrical body 100 in a state where the solvent vapor concentration of the solvent contained in the coating liquid L in the region Sa is held at a value equal to or higher than a determined value (for example, 5000 ppm) until the determined range 102 of the upper portion in the axial direction of the cylindrical body 100 passes through the region Sa determined from the liquid level L1 in the coating liquid holding part 12.

Therefore, according to the method for manufacturing a photoreceptor, the local film thickness unevenness of the coating layer of the cylindrical body 100 may be suppressed compared to a case where the solvent vapor concentration of the coating liquid in the region is lower than a determined value until the determined range 102 of the upper portion in the axial direction of the cylindrical body 100 passes through the region determined from the liquid level in the coating liquid holding part.

In the coating device 10 of the first exemplary embodiment, the vapor concentration holding part 70 sucks the gas inside the container 20 with the suction device 72 after the determined range 102 of the upper portion in the axial direction of the cylindrical body 100 has passed through the region Sa. However, the present disclosure is not limited to this configuration. For example, in a case where the vapor concentration holding part 70 can hold the solvent vapor concentration in the region Sa at a value equal to or higher than a determined value (for example, 5000 ppm) until the determined range 102 (refer to FIG. 3) of the upper portion in the axial direction of the cylindrical body 100 passes through the region Sa, the vapor concentration holding part 70 may suck the gas inside the container 20 by the suction device 72 with the start of movement of the cylindrical body 100 upward in the up-down direction with respect to the coating liquid holding part 12. With such a configuration, in the coating device, the suction of the gas by the suction device 72 may be easily controlled compared to a case of sucking the gas inside the container after the determined range 102 of the upper portion in the axial direction of the cylindrical body 100 has passed through the region.

### Second Exemplary Embodiment

Next, a coating device of a second exemplary embodiment will be described. The identical components to the configurations of the first exemplary embodiment described above will be denoted the identical reference numerals and the description thereof will be omitted.

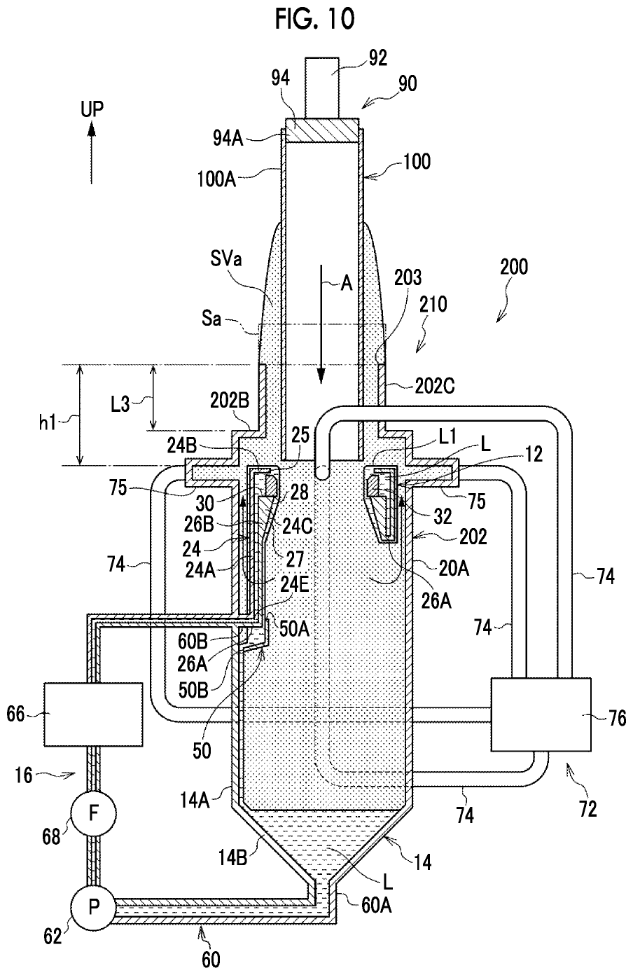

As shown in FIG. 10, a coating device 200 of the second exemplary embodiment includes a container 202 instead of the container 20 of the coating device 10 of the first exemplary embodiment. The container 202 includes a cylindrical portion 20A, a lateral wall portion 202B extending radially inward from the upper end portion of the cylindrical portion 20A, and a tubular portion 202C having a cylindrical shape and extending upward from the radially inner end portion of the lateral wall portion 202B. An opening 203 is formed at the upper end portion of the tubular portion 202C.

The outer diameter of the tubular portion 202C is smaller than the outer diameter of the cylindrical portion 20A, and the inner diameter of the tubular portion 202C is larger than the outer diameter of the cylindrical body 100. In this way, the cylindrical body 100 is inserted through the opening 203 of the tubular portion 202C.

A length L3 in the up-down direction of the tubular portion 202C is preferably, for example, 30 mm or shorter. The length L3 in the up-down direction of the tubular portion 202C is, for example, 10 mm.

A vapor concentration holding part 210 includes the storage part 14, the circulation part 16, and the suction device 72. The vapor concentration holding part 210 has a function of holding the solvent vapor concentration of the solvent contained in the coating liquid L in the region Sa at a value equal to or higher than a determined value (for example, 5000 ppm) until the determined range 102 (refer to FIG. 3) of the upper portion in the axial direction of the cylindrical body 100 passes through the region Sa determined from the liquid level L1 in the coating liquid holding part 12.

In the coating device 200, the region Sa determined from the liquid level L1 in the coating liquid holding part 12 is a region located above the opening 203 of the container 202 and having the height of 40 mm or lower from the liquid level L1 in the coating liquid holding part 12. More specifically, when the height from the liquid level L1 in the coating liquid holding part 12 to the upper surface of an edge portion of the opening 203 of the container 202 is set to be h1, the region Sa determined from the liquid level L1 in the coating liquid holding part 12 is a region located above the height h1 from the liquid level L1 and having the height of 40 mm or lower from the liquid level L1.

Other configurations of the coating device 200 are the same as the configurations of the coating device 10 of the first exemplary embodiment.

In the coating device 200 described above, the same operation and effect can be obtained with the same configuration as the coating device 10 of the first exemplary embodiment.

### Supplementary Description

In the first and second exemplary embodiments, the cylindrical body 100 is used as an example of the base material. However, the present disclosure is not limited thereto, and a tubular base material or a columnar base material other than the cylindrical body 100 may be used.

In the first and second exemplary embodiments, the configuration of each member of the coating liquid holding part 12 can be changed as long as the configuration is a configuration which allows the coating liquid L to be applied to the outer peripheral surface 100A of the cylindrical body 100.

In the first and second exemplary embodiments, the circulation part 16 is configured to circulate the coating liquid L between the coating liquid holding part 12 and the storage part 14 at the lower portion of the container 20. However, the present disclosure is not limited to this configuration. For example, a configuration may be made such that the coating liquid L is supplied to the coating liquid holding part 12 without being circulated.

In the first and second exemplary embodiments, the moving device 90 is configured to move the cylindrical body 100 in the up-down direction without moving the coating liquid holding part 12. However, the present disclosure is not limited to this configuration. For example, as long as the cylindrical body 100 is relatively moved in the up-down direction with respect to the coating liquid holding part 12, the configuration of the moving device and the relative movement operation can be changed.

Although the present disclosure has been described in detail with respect to the specific exemplary embodiments, it will be apparent to the persons skilled in the art that the present disclosure is not limited to such exemplary embodiments and that various other embodiments are possible within the scope of the present disclosure.

### Examples

Hereinafter, the coating device of the present disclosure will be more specifically described by way of examples. The coating device of the present disclosure is not limited to the following examples as long as the gist thereof is not exceeded.

In Examples 1 to 4, the coating device 10 is used, and the difference (V-Vc) between the internal volume V of the cylindrical body 100 and the volume Vc of the insertion portion 94A of the holder 94 into the cylindrical body 100, and the volume S of the region Sa determined from the liquid level L1 in the coating liquid holding part 12 are changed. Further, the vapor concentration in the region Sa when the position of 100 mm from the upper end of the cylindrical body 100 (the base material) passes is changed. Then, the grade of cissing of the coating layer of the cylindrical body 100 (that is, the local film thickness unevenness of the coating layer) and the grade of the film thickness unevenness of the coating layer of the cylindrical body 100 are evaluated. In Examples 1 to 4, the expression (V−Vc)>S is satisfied.

In Examples 1 to 4, ring coating refers to coating of the coating liquid L to the cylindrical body 100 by the annular body 32 of the coating liquid holding part 12. In Examples 1 and 2, a net-type hood is provided so as to surround the upper portion of the cylindrical body 100. Further, in Examples 3 and 4, a cylinder-type hood is provided so as to surround the upper portion of the cylindrical body 100.

The grade of the cissing of the coating layer of the cylindrical body 100 (that is, the local film thickness unevenness of the coating layer) is evaluated from G0 to G5, and the local film thickness unevenness of the coating layer increases as the numerical value after G increases. The cissing (that is, the local film thickness unevenness of the coating layer) is evaluated with the occurrence of a circular or elliptical thin film portion having a diameter or major axis length of 1 mm or longer and 5 mm or shorter. Further, a method for determining the cissing (that is, the local film thickness unevenness of the coating layer) is based on the result of film thickness measurement, not by visual inspection, and when the difference in film thickness from a non-occurrence portion on the same circumference of the cylindrical body 100 is 1 μm or more, it is determined that the cissing occurred. The grade of the cissing of the coating layer (that is, the local film thickness unevenness of the coating layer) of the cylindrical body 100 is acceptable when it is G1 or lower.

The grade of the film thickness unevenness of the coating layer of the cylindrical body 100 is evaluated from G0 to G5, and the film thickness unevenness of the coating layer increases as the numerical value after G increases. The film thickness unevenness of the coating layer of the cylindrical body 100 is evaluated with the difference (maximum value-minimum value) between the maximum value and the minimum value of the film thicknesses in a biaxial direction. The difference (maximum value-minimum value) between the maximum value and the minimum value of the film thicknesses in the biaxial direction is defined as G1 when it falls within 10% of the average film thickness. The grade of the film thickness unevenness of the coating layer of the cylindrical body 100 is acceptable when it is G2 or lower.

In Comparative Examples 1 to 7, the coating device 10 is used, and the difference (V−Vc) between the internal volume V of the cylindrical body 100 and the volume Vc of the insertion portion 94A of the holder 94 into the cylindrical body 100, and the volume S of the region Sa determined from the liquid level L1 in the coating liquid holding part 12 are changed. Further, in Comparative Examples 4 to 6, the inside of the container is left unsealed except for the opening at the time of coating standby of the coating liquid L (that is, the gas inside the container is sucked by the suction device 72). Further, in Comparative Examples 1 to 6, the vapor concentration in the region Sa when the position of 100 mm from the upper end of the cylindrical body 100 (the base material) passes is set to be concentration lower than 5000 ppm. Further, in Comparative Examples 5 to 7, the coating liquid L is applied to the cylindrical body 100 by dipping the cylindrical body 100 in the coating liquid L in a tank. Then, the grade of cissing of the coating layer of the cylindrical body 100 (that is, the local film thickness unevenness of the coating layer) and the grade of the film thickness unevenness of the coating layer of the cylindrical body 100 are evaluated.

The evaluation results of Examples 1 to 4 and Comparative Examples 1 to 7 are shown in Table 1.

TABLE 1

| | | | | | | Presence or | | Vapor | | |
|---|---|---|---|---|---|---|---|---|---|---|
| | | | | | | absence of | | concentration | | |
| | | | | | | container | | in region when | | |
| | | | | | | inside | Retention | 100 mm | | |
| | | | | | | sealing at | time | position of | | Film |
| | | (V − | | (V − | | time of | before | base material | | thickness |
| | Coating | Vc) | | Vc) − | Hood | coating | coating | passes | Cissing | unevenness |
| | method | [m³] | S | S | type | standby | [min] | [ppm] | grade | grade |
| Example 1 | Ring coating | 0.00025 | 0.00019 | 0.00003 | Net | Presence | 3 | 5000 | G0 | G0 |
| Example 2 | ↑ | 0.00195 | 0.00043 | 0.00130 | ↑ | Presence | 3 | 10000> | G0 | G0 |
| Example 3 | ↑ | 0.00025 | 0.00019 | 0.00003 | Cylinder | Presence | 3 | 8000 | G0 | G0 |
| Example 4 | ↑ | 0.00195 | 0.00043 | 0.00130 | ↑ | Presence | 3 | 10000> | G0 | G1 |
| Comparative | Ring coating | 0.00017 | 0.00019 | −0.00005 | Net | Presence | 3 | 1000 | G4 | G0 |
| example 1 | | | | | | | | | | |
| Comparative | ↑ | 0.00017 | 0.00019 | −0.00005 | Cylinder | Presence | 3 | 2000 | G3 | G0 |
| example 2 | | | | | | | | | | |
| Comparative | ↑ | 0.00195 | 0.00043 | 0.00130 | Net | Presence | 2 | 2500 | G2 | G0 |
| example 3 | | | | | | | | | | |
| Comparative | ↑ | 000195 | 0.00043 | 0.00130 | Net | Absence | 3 | 0 | G4 | G0 |
| example 4 | | | | | | | | | | |
| Comparative | Dip coating | 0.00022 | 0.00195 | 0.00043 | Net | Absence | 3 | 0 | G5 | G0 |
| example 5 | | | | | | | | | | |
| Comparative | ↑ | 0.00022 | 0.00195 | 0.00043 | Cylinder | Absence | 3 | 1000 | G5 | G1 |
| example 6 | | | | | | | | | | |
| Comparative | Dip coating × | 0.00022 | 0.00195 | 0.00043 | Cylinder | Presence | 3 | 6000 | G0 | G5 |
| example 7 | container inside | | | | | | | | | |
| | sealing | | | | | | | | | |

As shown in Table 1, in Examples 1 to 4, it is confirmed that both the grade of the cissing of the coating layer (that is, the local film thickness unevenness of the coating layer) of the cylindrical body 100 and the grade of the film thickness unevenness of the coating layer of the cylindrical body 100 are good.

In contrast, it is confirmed that in Comparative Examples 1 to 6, the occurrence of the cissing of the coating layer (that is, the local film thickness unevenness of the coating layer) of the cylindrical body 100 is at an unacceptable level, and in Comparative Example 7, the film thickness unevenness of the coating layer of the cylindrical body 100 is at an unacceptable level.

### Supplementary Note

Hereinafter, aspects of the present disclosure will be additionally described.

(((1)))

A coating device comprising:
a coating liquid holding part that has an upper opening portion and a lower opening portion and holds a coating liquid, in which the coating liquid is applied to an outer peripheral surface of a base material having a tubular shape by causing the base material to penetrate the upper opening portion and the lower opening portion of the coating liquid holding part and relatively moving the base material upward in an up-down direction;
a container that surrounds the coating liquid holding part and has, at an upper portion, an opening into which the base material penetrating the coating liquid holding part is inserted; and
a vapor concentration holding part that holds solvent vapor concentration of a solvent contained in the coating liquid in a region determined from a liquid level in the coating liquid holding part at a value equal to or higher than a determined value until a determined range of an upper portion in an axial direction of the base material passes through the region.
   (((2)))

In the coating device according to (((1))),
wherein the coating liquid is a coating liquid for forming a protective layer on the outer peripheral surface of the base material, and
the vapor concentration holding part holds the solvent vapor concentration in the region at 5000 ppm or higher until the determined range of the upper portion in the axial direction of the base material passes through the region.
   (((3)))

In the coating device according to (((1))) or (((2))),
wherein the coating liquid in which the solvent has a boiling point of 70° C. or higher and 110° C. or lower is used.
   (((4)))

In the coating device according to (((2))) or (((3))),
wherein the vapor concentration holding part holds the solvent vapor concentration inside the container at 10000 ppm or higher before the base material penetrates the coating liquid holding part as a pre-step of applying the coating liquid.
   (((5)))

In the coating device according to any one of (((1))) to (((4))),
wherein the vapor concentration holding part includes
a coating liquid supply part that supplies the coating liquid to the coating liquid holding part,
a coating liquid receiving part that is provided in the container and receives the coating liquid flowing down from the coating liquid holding part,
a sealing unit that seals portions other than the opening of the container, and
a releasing unit that releases the sealing.
   (((6)))

In the coating device according to (((5))),
wherein the releasing unit includes a suction part that is connected to the container and sucks a gas inside the container.
   (((7))),

In the coating device according to (((6))),
wherein the suction part includes
a ventilation pipe that is connected to the container at a position equal to or lower than a height of the liquid level of the coating liquid inside the coating liquid holding part, and a gas suction machine that is provided in the ventilation pipe.
   (((8)))

In the coating device according to (((7))),
wherein the container has a cylindrical shape, and
the ventilation pipes are connected to positions of three or more locations at equal intervals along a circumferential direction of the container.
   (((9)))

In the coating device according to any one of (((6))) to (((8))),
wherein the vapor concentration holding part blocks suction of the gas inside the container by the suction part until the determined range of the upper portion in the axial direction of the base material passes through the region.
   (((10)))

In the coating device according to (((9))),
wherein the vapor concentration holding part sucks the gas inside the container by the suction part after the determined range of the upper portion in the axial direction of the base material has passed through the region.
   (((11)))

In the coating device according to any one of (((6))) to (((8))),
wherein the vapor concentration holding part sucks the gas inside the container by the suction part with a start of movement of the base material upward in the up-down direction with respect to the coating liquid holding part.
   (((12)))

In the coating device according to any one of (((1))) to (((11))),
wherein the base material has a cylindrical shape and includes a holder that holds the upper portion in the axial direction of the base material from the inside, and
in a case where an inner diameter of the base material is denoted by r, a length of the base material is set to be L, internal volume of the base material is set to be V, an inner diameter of the opening of the container is set to be R, volume of an insertion portion of the holder into the base material is set to be Vc, a height from the liquid level in the coating liquid holding part to an upper surface of an edge portion of the opening of the container is set to be h1, a difference between a position of a height of 40 mm from the liquid level in the coating liquid holding part and the height h1 is set to be h2, and volume of the region located above the opening of the container and having a height of 40 mm from the liquid level in the coating liquid holding part is set to be S,
the vapor concentration holding part is a part for moving solvent vapor of the coating liquid in the container to a range that includes the region above the opening of the container in a case where the base material whose upper end is sealed is moved from top to bottom and set in the coating liquid holding part,
a retention time from the setting to a start of application of the coating liquid is set to be a time equal to or longer than a determined time, and
a configuration is made such that the following expressions are satisfied

$$V - Vc > S$$

$$V = {( r / 2 )}^{2} \times π \times L$$

$$S = {( R / 2 )}^{2} \times π \times h 2$$

$$h 2 = 40 - h 1.$$

(((13)))

In the coating device according to any one of (((1))) to (((12))),
wherein the determined range of the upper portion in the axial direction of the base material is a range of 20 mm from an upper end of the base material.
   (((14)))

A method for manufacturing a photoreceptor by applying a coating liquid to an outer peripheral surface of a base material having a cylindrical shape by using the coating device according to any one of (((1))) to (((13))), the method comprising:
applying the coating liquid to the base material by causing the base material to penetrate the coating liquid holding part and relatively moving the base material upward in the up-down direction with respect to the coating liquid holding part,
wherein in the applying of the coating liquid to the base material, the coating liquid is applied to the outer peripheral surface of the base material in a state where the solvent vapor concentration of the solvent contained in the coating liquid in the region determined from the liquid level in the coating liquid holding part is held at the value equal to or higher than the determined value until the determined range of the upper portion in the axial direction of the base material passes through the region.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A coating device comprising:
a coating liquid holding part that has an upper opening portion and a lower opening portion and holds a coating liquid, in which the coating liquid is applied to an outer peripheral surface of a base material having a tubular shape by causing the base material to penetrate the upper opening portion and the lower opening portion of the coating liquid holding part and relatively moving the base material upward in an up-down direction;
a container that surrounds the coating liquid holding part and has, at an upper portion, an opening into which the base material penetrating the coating liquid holding part is inserted; and
a vapor concentration holding part that holds solvent vapor concentration of a solvent contained in the coating liquid in a region determined from a liquid level in the coating liquid holding part at a value equal to or higher than a determined value until a determined range of an upper portion in an axial direction of the base material passes through the region.

2. The coating device according to claim 1,
wherein the coating liquid is a coating liquid for forming a protective layer on the outer peripheral surface of the base material, and
the vapor concentration holding part holds the solvent vapor concentration in the region at 5000 ppm or higher until the determined range of the upper portion in the axial direction of the base material passes through the region.

3. The coating device according to claim 2,
wherein the coating liquid in which the solvent has a boiling point of 70° C. or higher and 110° C. or lower is used.

4. The coating device according to claim 2,
wherein the vapor concentration holding part holds the solvent vapor concentration inside the container at 10000 ppm or higher before the base material penetrates the coating liquid holding part as a pre-step of applying the coating liquid.

5. The coating device according to claim 1,
wherein the vapor concentration holding part includes a coating liquid supply part that supplies the coating liquid to the coating liquid holding part,
a coating liquid receiving part that is provided in the container and receives the coating liquid flowing down from the coating liquid holding part,
a sealing unit that seals portions other than the opening of the container, and
a releasing unit that releases the sealing.

6. The coating device according to claim 5,
wherein the releasing unit includes a suction part that is connected to the container and sucks a gas inside the container.

7. The coating device according to claim 6,
wherein the suction part includes
a ventilation pipe that is connected to the container at a position equal to or lower than a height of the liquid level of the coating liquid inside the coating liquid holding part, and
a gas suction machine that is provided in the ventilation pipe.

8. The coating device according to claim 7,
wherein the container has a cylindrical shape, and
the ventilation pipes are connected to positions of three or more locations at equal intervals along a circumferential direction of the container.

9. The coating device according to claim 6,
wherein the vapor concentration holding part blocks suction of the gas inside the container by the suction part until the determined range of the upper portion in the axial direction of the base material passes through the region.

10. The coating device according to claim 9,
wherein the vapor concentration holding part sucks the gas inside the container by the suction part after the determined range of the upper portion in the axial direction of the base material has passed through the region.

11. The coating device according to claim 6,
wherein the vapor concentration holding part sucks the gas inside the container by the suction part with a start of movement of the base material upward in the up-down direction with respect to the coating liquid holding part.

12. The coating device according to claim 1,
wherein the base material has a cylindrical shape and includes a holder that holds the upper portion in the axial direction of the base material from the inside, and
in a case where an inner diameter of the base material is denoted by r, a length of the base material is set to be L, internal volume of the base material is set to be V, an inner diameter of the opening of the container is set to be R, volume of an insertion portion of the holder into the base material is set to be Vc, a height from the liquid level in the coating liquid holding part to an upper surface of an edge portion of the opening of the container is set to be h1, a difference between a position of a height of 40 mm from the liquid level in the coating liquid holding part and the height h1 is set to be h2, and volume of the region located above the opening of the container and having a height of 40 mm from the liquid level in the coating liquid holding part is set to be S,
the vapor concentration holding part is a part for moving solvent vapor of the coating liquid in the container to a range that includes the region above the opening of the container in a case where the base material whose upper end is sealed is moved from top to bottom and set in the coating liquid holding part,
a retention time from the setting to a start of application of the coating liquid is set to be a time equal to or longer than a determined time, and
a configuration is made such that the following expressions are satisfied
$$V - Vc > S$$
$$V = {( r / 2 )}^{2} \times π \times L$$
$$S = {( R / 2 )}^{2} \times π \times h 2$$
$$h 2 = 40 - h 1.$$

13. The coating device according to claim 1,
wherein the determined range of the upper portion in the axial direction of the base material is a range of 20 mm from an upper end of the base material.

14. A method for manufacturing a photoreceptor by applying a coating liquid to an outer peripheral surface of a base material having a cylindrical shape by using the coating device according to claim 1, the method comprising:
applying the coating liquid to the base material by causing the base material to penetrate the coating liquid holding part and relatively moving the base material upward in the up-down direction with respect to the coating liquid holding part,
wherein in the applying of the coating liquid to the base material, the coating liquid is applied to the outer peripheral surface of the base material in a state where the solvent vapor concentration of the solvent contained in the coating liquid in the region determined from the liquid level in the coating liquid holding part is held at the value equal to or higher than the determined value until the determined range of the upper portion in the axial direction of the base material passes through the region.

15. A method for manufacturing a photoreceptor by applying a coating liquid to an outer peripheral surface of a base material having a cylindrical shape by using the coating device according to claim 2, the method comprising:
applying the coating liquid to the base material by causing the base material to penetrate the coating liquid holding part and relatively moving the base material upward in the up-down direction with respect to the coating liquid holding part,
wherein in the applying of the coating liquid to the base material, the coating liquid is applied to the outer peripheral surface of the base material in a state where the solvent vapor concentration of the solvent contained in the coating liquid in the region determined from the liquid level in the coating liquid holding part is held at the value equal to or higher than the determined value until the determined range of the upper portion in the axial direction of the base material passes through the region.

16. A method for manufacturing a photoreceptor by applying a coating liquid to an outer peripheral surface of a base material having a cylindrical shape by using the coating device according to claim 3, the method comprising:
applying the coating liquid to the base material by causing the base material to penetrate the coating liquid holding part and relatively moving the base material upward in the up-down direction with respect to the coating liquid holding part,
wherein in the applying of the coating liquid to the base material, the coating liquid is applied to the outer peripheral surface of the base material in a state where the solvent vapor concentration of the solvent contained in the coating liquid in the region determined from the liquid level in the coating liquid holding part is held at the value equal to or higher than the determined value until the determined range of the upper portion in the axial direction of the base material passes through the region.

17. A method for manufacturing a photoreceptor by applying a coating liquid to an outer peripheral surface of a base material having a cylindrical shape by using the coating device according to claim 4, the method comprising:
applying the coating liquid to the base material by causing the base material to penetrate the coating liquid holding part and relatively moving the base material upward in the up-down direction with respect to the coating liquid holding part,
wherein in the applying of the coating liquid to the base material, the coating liquid is applied to the outer peripheral surface of the base material in a state where the solvent vapor concentration of the solvent contained in the coating liquid in the region determined from the liquid level in the coating liquid holding part is held at the value equal to or higher than the determined value until the determined range of the upper portion in the axial direction of the base material passes through the region.

18. A method for manufacturing a photoreceptor by applying a coating liquid to an outer peripheral surface of a base material having a cylindrical shape by using the coating device according to claim 5, the method comprising:
applying the coating liquid to the base material by causing the base material to penetrate the coating liquid holding part and relatively moving the base material upward in the up-down direction with respect to the coating liquid holding part,
wherein in the applying of the coating liquid to the base material, the coating liquid is applied to the outer peripheral surface of the base material in a state where the solvent vapor concentration of the solvent contained in the coating liquid in the region determined from the liquid level in the coating liquid holding part is held at the value equal to or higher than the determined value until the determined range of the upper portion in the axial direction of the base material passes through the region.

19. A method for manufacturing a photoreceptor by applying a coating liquid to an outer peripheral surface of a base material having a cylindrical shape by using the coating device according to claim 6, the method comprising:
applying the coating liquid to the base material by causing the base material to penetrate the coating liquid holding part and relatively moving the base material upward in the up-down direction with respect to the coating liquid holding part,
wherein in the applying of the coating liquid to the base material, the coating liquid is applied to the outer peripheral surface of the base material in a state where the solvent vapor concentration of the solvent contained in the coating liquid in the region determined from the liquid level in the coating liquid holding part is held at the value equal to or higher than the determined value until the determined range of the upper portion in the axial direction of the base material passes through the region.

20. A method for manufacturing a photoreceptor by applying a coating liquid to an outer peripheral surface of a base material having a cylindrical shape by using the coating device according to claim 7, the method comprising:
applying the coating liquid to the base material by causing the base material to penetrate the coating liquid holding part and relatively moving the base material upward in the up-down direction with respect to the coating liquid holding part,
wherein in the applying of the coating liquid to the base material, the coating liquid is applied to the outer peripheral surface of the base material in a state where the solvent vapor concentration of the solvent contained in the coating liquid in the region determined from the liquid level in the coating liquid holding part is held at the value equal to or higher than the determined value until the determined range of the upper portion in the axial direction of the base material passes through the region.
